(19) United States
(12) Patent Application Publication
(10) Pub. No.: US 2016/0012625 A1
(43) Pub. Date: Jan. 14, 2016

(54) System and Method of Masking

(71) Applicant: Jared Schnelle, McKinney, TX (US)

(72) Inventor: Jared Schnelle, McKinney, TX (US)

(21) Appl. No.: 14/797,495

(22) Filed: Jul. 13, 2015

Related U.S. Application Data
(60) Provisional application No. 62/024,429, filed on Jul. 14, 2014.

(51) Int. Cl. G06T 11/60; G06T 7/00; H04L 12/58

(52) U.S. Cl. CPC G06T 11/60; H04L 51/046; G06T 7/0081

(57) ABSTRACT

A system and method for masking an image. The method separates the image into at least two frames and alternately displays the two frames at a sufficiently high refresh rate so that the two images are viewed by a human eye as a single image. Thus, if a user were to take a screenshot, only a single, partial image, would be produced.

### PRIORITY

This application claims priority to U.S. Provisional application 62/024,429 entitled System and Method of Masking filed Jul. 14, 2014, the entirety of which is incorporated herein by reference.

### TECHNICAL FIELD

The present invention relates to a system and method for masking an image or text.

### DESCRIPTION OF RELATED ART

Protecting consumer privacy is a growing concern in today's software. Communication software in particular is moving towards becoming more ephemeral with some content lasting only a few seconds. However, all of the privacy provided by the new class of ephemeral software is done away with the basic operating system function of a screenshot which saves all of the content visible at that moment into a photo on the device or computer. Generally speaking, it is not possible to prevent the screenshot from taking place. Consequently, there is a need for a method and system for distorting an image to minimize the content obtained in a screenshot.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a sequence assigning frames to letters in one embodiment;

FIG. 2A is a screenshot of Frame A in one embodiment;

FIG. 2B is a screenshot of Frame B in one embodiment;

FIG. 2C is a screenshot of Frames A and B as they appear to the human eye in one embodiment;

FIG. 2D is a screenshot of Frames A and B with vertical offset in one embodiment;

FIG. 3A is a screenshot of Frame A in one embodiment;

FIG. 3B is a screenshot of Frame B in one embodiment;

FIG. 3C is a screenshot of Frames A and B combined in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

As noted, there are several applications which serve to delete texts and pictures after a period of time. The goal in such applications to convey a text or image without fear that the text or image could be saved, circulated, etc. This goal is frustrated with a screenshot. A screenshot is an image which is saved from the screen of a computer, phone, tablet, etc. Many phones and computers have the ability to easily capture the image or text via a screenshot.

In one embodiment, a system and method is provided which reduces the information captured with screenshots by masking out portions of the content being drawn to the screen at any given moment. The masked portions of the content are changed rapidly which allows the human brain to aggregate the visible parts into a coherent image or sentence. However, when a screenshot is taken at any moment in time, only a part of the content is visible thus the privacy of the consumer is increased. Masking involves scrambling or hiding a portion of an image or text. In one embodiment, masking comprises placing a grid of squares over the photo content. In other embodiments the masking comprises masking individual letters out in a block of text.

Virtually any image, including but not limited to text, photographs, pictures, drawings, sketches, etc. can be masked using methods and systems discussed herein. The masking can be utilized in any type of electronic communication including email, texts, instant messages, etc.

In one embodiment, communications comprising solely of text are protected from screenshots by using an algorithm wherein the string of text is split into two or more frames which are rendered on top of one another at a high frame rate. The frame rate, in one embodiment, changes with the performance of the device. In one embodiment, the frame rate is above about 30 frames per second. In one embodiment the frame rate ranges from about 60-120 frames per second. The result is a blending of the frames and a well formed text string, such as a sentence, phrase, etc. that is readable by a human. When a screenshot is taken on a device, only the currently drawn frame is available to be captured and thus only a portion of the message is captured. The individual frames can comprise entire words or a pattern of characters.

As an example, consider the sentence: “The quick brown fox jumps over the lazy dog” sent from a first user, followed by the reply “A wizard's job is to vex chumps quickly in fog” sent from a second user. Without masking, a screenshot could capture and save the entire text string between the first user and the second user. However, using the method and system described herein, the text messages can be masked, preventing a single screenshot from capturing and storing the text.

In one embodiment, to mask the text, the algorithm uses all of the even numbered letters in Frame A and odd numbered letters in Frame B. FIG. 1 is a sequence assigning frames to letters in one embodiment. As depicted, the characters are numbered from the beginning of the string to the end starting with a zero index. All characters are counted. As depicted, characters include spaces, numbers, and character sets like ASCII. Accordingly, the “T” and “E” in “THE” is assigned Frame A whereas “H” in “THE” is assigned Frame B.

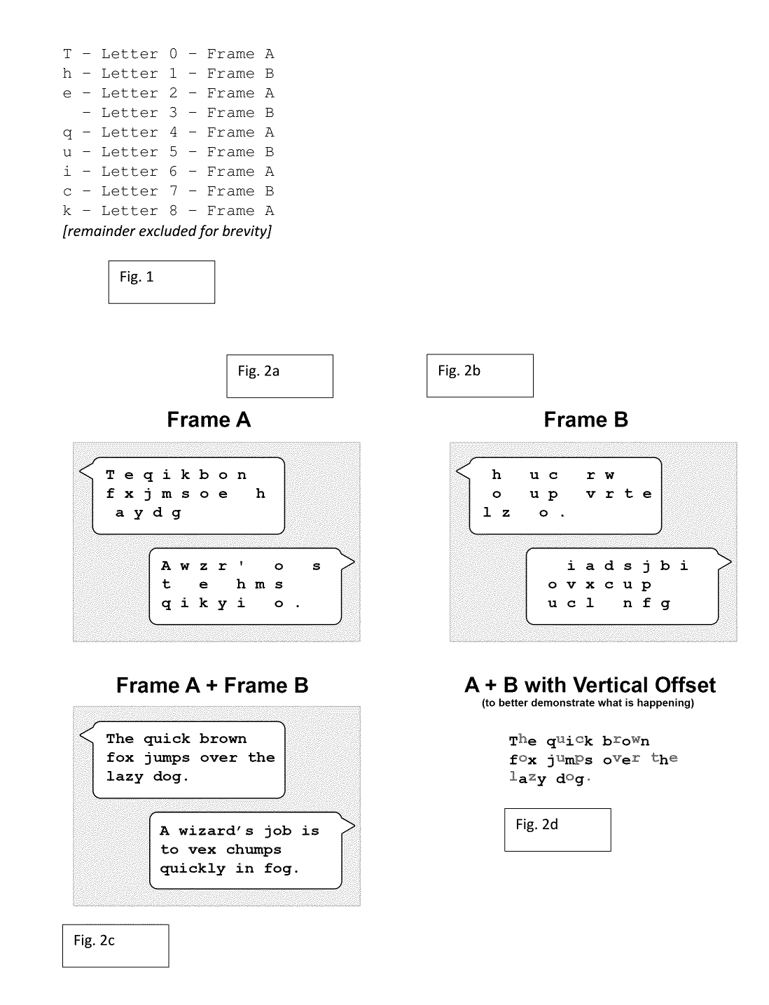

Once assigned, the two Frames, Frame A and Frame B, change quickly so that the human eye sees a constant image. However, at a given point, there are two possible screenshots that can be saved by a device, such as a phone, computer, or tablet. FIG. 2A is a screenshot of Frame A in one embodiment, and FIG. 2B is a screenshot of Frame B in one embodiment. As can be seen in Frame A, only the “T” and “E” of the word “THE” are in the first portion of Frame A. The missing “H” is in Part B. Reviewing Frame A alone, without the benefit of Frame B, does not convey the message Likewise, reviewing Frame B, in isolation, does not convey the message. Rather, Frame A and B display only the unmasked portion of the message. Thus, if one of the users attempted to get a screenshot of the text string, the result would be either Frame A or Frame B.

FIG. 2C is a screenshot of Frames A and B as they appear to the human eye. This demonstrates that the user will be able to read and understand the image, even when a screenshot of the image is unreadable.

FIG. 2D is a screenshot of Frames A and B with vertical offset in one embodiment. The vertical offset better illustrates how the two frames join to form a readable text or image. Frame B has been offset vertically relative to Frame A to demonstrate the sources of the text.

While two frames have been demonstrated, this is for illustrative purposes only and should not be deemed limiting. In other embodiments two or more frames are utilized, depending on the refresh rate of the image. Each frame that is added, reduces the amount of information that may be obtained in a single screenshot. Further, while an algorithm has been disclosed wherein even characters are assigned Frame A and odd characters are assigned Frame B, this should not be deemed limiting. In other embodiments complicated codes and patterns dictate which characters are located on the different frames. For example, in one embodiment, the spaces between words are distributed evenly between the two frames as the spaces make it difficult to see the word boundaries.

In one embodiment, images that are communicated can be protected from screenshots in a similar manner to text content. In one embodiment, a mask is used to control which parts of an image are rendered on any given frame. The frames are switched at a sufficient frame rate such that the image can be constructed in the mind. Individual frames contain only a portion of the actual image and thus a screenshot capture of the frame lowers the amount of information that is captured. For demonstration purposes, the example utilizes a simple mask comprised of a grid of squares. In one embodiment, the mask can be transparent, or any shade of black, including white. This is for illustrative purposes only as more complex masks and shapes could be used in practical situations in order to further obfuscate the underlying image. For example, other more complicated shapes such as alternating triangles, fractal shapes, such as snowflakes, and other shapes can be used.

In one embodiment, an algorithm calculates the number of frames which are used for an image. Thus, the number of frames utilized can change depending upon the complexity of the image, for example.

In one embodiment, the masking can change the darkness or color tint of the image perceived by the human eye. To counteract this, and to obtain an image as perceived by the human eye that more closely resembles the communicated image, the brightness and color of the output image can be altered by using an additional mask of a different color. For example, a white mask can be balanced with a black mask. As but one non-limiting example, in one embodiment the overall brightness of an image is calculated, thereafter the maximum amount of darkening or lightening that could be used and still provide an acceptable image can be calculated.

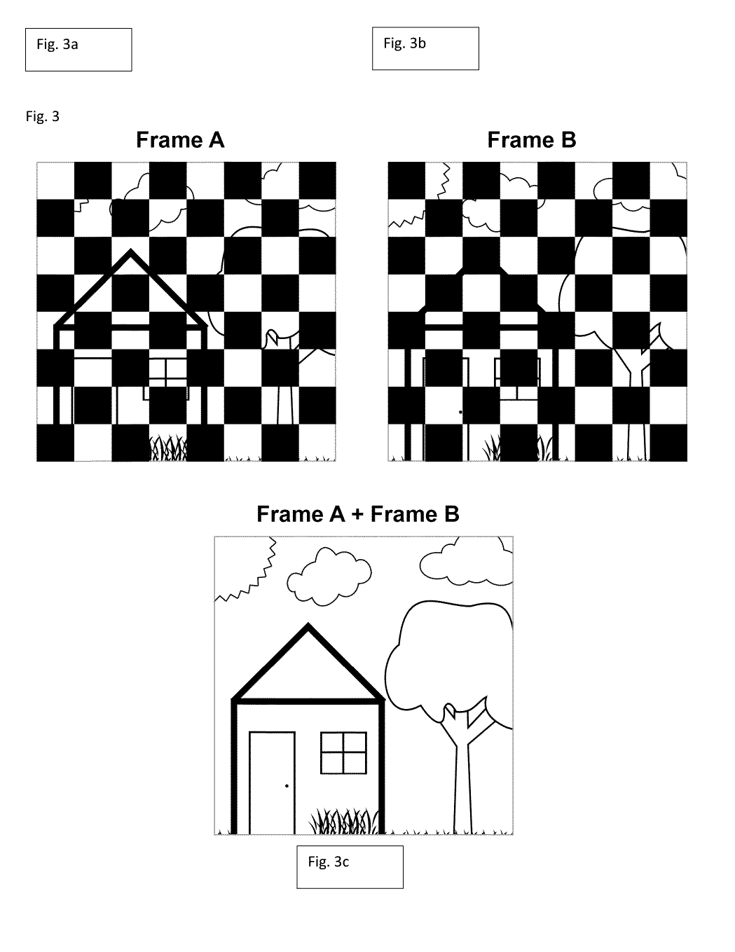

FIG. 3A is a screenshot of Frame A in one embodiment. As can be seen, a grid of squares blocks a portion of the image. FIG. 3B is a screenshot of Frame B in one embodiment. In this embodiment the grid of squares blocks the inverse image. As with the text examples above, if a user captures a screenshot, the user will only capture either Frame A or Frame B.

FIG. 3C is a screenshot of Frames A and B combined in one embodiment. In one embodiment, the image in FIG. 3C is how a human will see the image.

While the invention has been particularly shown and described with reference to a preferred embodiment, it will be understood by those skilled in the art that various changes in form and detail may be made therein without departing from the spirit and scope of the invention.

### ADDITIONAL DESCRIPTION

The following clauses are offered as further description of the disclosed invention.

Clause 1. A method of masking a text communication, said method comprising:

a. assigning characters of a text message to one of at least two groups;

b. alternating displays of said at least two groups at such a rate so that a human eye perceives a single text message, but wherein a single group displays only a portion of said text message.

Clause 2. The method of any proceeding or preceding clause wherein said text communication comprises a text message.

Clause 3. The method of any proceeding or preceding clause wherein said text communication comprises an email.

Clause 4. The method of any proceeding or preceding clause wherein said assigning of step a) comprises an algorithm.

Clause 5. The method of any proceeding or preceding clause wherein said displays of step b) comprise a smart phone.

Clause 6. A method of masking an image, said method comprising:

a. splitting an image into at least a first frame and a second frame, wherein each of said first and said second frame comprises a partially masked portion of said image;

b. displaying said first and second frame alternately at such a rate that the human eye perceives the image as a single image.

Clause 7. The method of any proceeding or preceding clause wherein said image is sent via text message.

Clause 8. The method of any proceeding or preceding clause wherein said masking of step a) comprises blocks.

What is claimed is:

1. A method of masking a text communication, said method comprising:
a. assigning characters of a text message to one of at least two groups;
b. alternating displays of said at least two groups at such a rate so that a human eye perceives a single text message, but wherein a single group displays only a portion of said text message.

2. The method of claim 1 wherein said text communication comprises a text message.

3. The method of claim 1 wherein said text communication comprises an email.

4. The method of claim 1 wherein said assigning of step a) comprises an algorithm.

5. The method of claim 1 wherein said displays of step b) comprise a smart phone.

6. A method of masking an image, said method comprising:
a. splitting an image into at least a first frame and a second frame, wherein each of said first and said second frame comprises a partially masked portion of said image;
b. displaying said first and second frame alternately at such a rate that the human eye perceives the image as a single image.

7. The method of claim 6 wherein said image is sent via text message.

8. The method of claim 6 wherein said masking of step a) comprises blocks.
